(19) United States
(12) Patent Application Publication
(10) Pub. No.: US 2017/0306223 A1
(43) Pub. Date: Oct. 26, 2017

(54) PHOSPHORS

(71) Applicant: MERCK PATENT GMBH, Darmstadt (DE)

(72) Inventors: Ralf PETRY, Griesheim (DE); Holger WINKLER, Darmstadt (DE); Thomas JUESTEL, Witten (DE); Tobias DIERKES, Muenster (DE)

(73) Assignee: MERCK PATENT GMBH, Darmstadt (DE)

(21) Appl. No.: 15/517,829

(22) PCT Filed: Sep. 22, 2015
(86) PCT No.: PCT/EP2015/001879

§ 371 Date: Apr. 7, 2017

(30) Foreign Application Priority Data
Oct. 9, 2014 (EP) 14003462.0

(51) Int. Cl. C09K 11/70; C09K 11/77; C09K 11/08; C09K 11/07

(52) U.S. Cl. CPC C09K 11/70; C09K 11/7759; C09K 11/07; C09K 11/0877; C09K 11/7728

(57) ABSTRACT

The present invention relates to europium-, cerium-, samarium- or praseodymium-doped boronitrides, to a process for the preparation of these compounds, and to the use of the doped boronitrides according to the invention as conversion phosphors. The present invention furthermore relates to a light source which contains a doped boronitride according to the invention.

The present invention relates to europium-, cerium-, samarium- or praseodymium-doped boronitrides, to a process for the preparation of these compounds, and to the use of the compounds according to the invention as conversion phosphors. The present invention furthermore relates to a light-emitting device which contains a doped boronitride according to the invention.

Inorganic fluorescent powders which can be excited in the blue and/or UV spectral region have major importance as conversion phosphors for phosphor-converted LEDs, pc-LEDs for short. In the meantime, many conversion phosphor systems are known, such as, for example, alkaline-earth metal orthosilicates, thiogallates, garnets, nitrides and oxynitrides, each doped with Ce³⁺ or Eu²⁺. The last-mentioned nitride and oxynitride phosphors in particular are currently the subject of intensive research, since these materials exhibit red emission with emission wavelengths above 600 nm and are therefore of importance for the production of warm-white pc-LEDs having colour temperatures <4000 K.

A disadvantage on use of the above-mentioned phosphors for phosphor-converted LEDs is ageing at the phosphor/polymer interface, meaning that darkening of the converter layer and thus a decrease in brightness occurs. This is critical, in particular, for achieving very long lifetimes, since the encapsulation of the powder or ceramic converters takes place by means of epoxy or silicone resin. Unfortunately, both polymers are not diffusion-impermeable for small molecules such as H₂O, CO₂ or NH₃. These thus reach the converter during the operating time of the LED lamps and can initiate (photo)chemical reactions at the interfaces there. It is therefore of particular interest to find materials which have particularly high long-term stability, as is the case, for example, in the case of Si₃N₄, SiC or BN. However, such materials are frequently particularly difficult to prepare.

It would therefore be desirable to have available phosphors which have higher long-term stability. A further object on which the present application is based is the provision of further phosphors, in particular orange- to red-emitting phosphors, in order to provide the person skilled in the art with a greater choice of suitable phosphors for use in phosphor-converted LEDs. The object of the present invention was therefore to provide phosphors of this type.

Surprisingly, it has been found that the europium-, cerium-, samarium- and/or praseodymium-doped boronitrides described below achieve this object and are very highly suitable for use in phosphor-converted LEDs.

Z. Kristallogr. NCS. 220 (2005), 303-304 describes the crystal structure of EuBa₈(BN₂)₆, which can formally also be described stoichiometrically as Eu_{0.5}Ba₄(BN₂)₃. Luminescence properties of this compound are not described, neither is the use of this compound in a phosphor-converted LED. This compound is described as a black, air- and water-sensitive compound, meaning that it is not suitable for use as phosphor.

Journal of Solid State Chemistry 182 (2009), 3299-3304 discloses the synthesis and luminescence properties of Eu²⁺-activated Ca₂BN₂F. The compound is described here as emitting deep blue. This compound is thus not suitable as orange- to red-emitting phosphor.

The invention relates to a europium-, cerium-, samarium- and/or praseodymium-doped compound, where the dopant is present in an amount of up to 10 mol %, of the following formula (1),

Aₐ(EA)_{b}(Ln)_{c}BₑN_{2e+f}O_{g}(BNO)ₕ(Hal)ᵢ formula (1)

in which the following applies to the symbols and indices used:
A are one or more elements selected from the group consisting of Li, Na and K;
EA are one or more elements selected from the group consisting of Mg, Ca, Sr and Ba;
Ln are one or more elements selected from the group consisting of Sc, Y, La, Gd and Lu;
Hal are one or more elements selected from the group consisting of F, Cl, Br and I;
0≦a≦3;
0≦b≦5;
0≦c≦6;
1≦e≦4;
0≦f≦2;
0≦g≦6;
0≦h≦1;
0≦i≦1;
where the following furthermore applies to the indices:

a+2b+3c=3e+3f+2g+2h+i;

2≦a+b+c≦6;

2≦e+f+g+h+i≦6;
where the compound Ca₂BN₂F:Eu is excluded from the invention.

The prerequisite a+2b+3c=3e+3f+2g+2h+i, as defined above, results in the compound being a charge-neutral compound.

B, N and O in formula (1) stand, in accordance with conventional chemical nomenclature, for boron, nitrogen and oxygen respectively.

The compounds according to the invention are boronitrides which contain boron and at least double the stoichiometric number of nitrogen atoms. The units which contain boron and nitrogen here are (BN₂)³⁻ units, which may also be in the form of a dimer (B₂N₄)⁶⁻ or trimer (B₃N₆)⁹⁻, or (BN₃)⁶⁻ units.

If the compound is doped with Eu, the Eu is in the form of Eu²⁺ or Eu³⁺, where Eu²⁺ replaces either two alkali metals A or one alkaline-earth metal EA, preferably one alkaline-earth metal EA, or Eu³⁺ replaces one lanthanoid metal Ln.

If the compound is doped with Ce, the Ce is in the form of Ce³⁺ and replaces one alkaline-earth metal EA or preferably one lanthanoid metal Ln. If the compound is doped with Sm, the Sm is in the form of Sm²⁺ or Sm³⁺, where Sm²⁺ replaces either two alkali metals A or one alkaline-earth metal EA, preferably one alkaline-earth metal EA, or Sm³⁺ replaces one lanthanoid metal Ln.

If the compound is doped with Pr, the Pr is in the form of Pr³⁺ and replaces one alkaline-earth metal EA or preferably one lanthanoid metal Ln.

As described above, the dopant (=activator), i.e. Eu, Ce, Sm and/or Pr, is present in a total amount of up to 10 mol %. The amount of up to 10 mol % here means that the dopant is present in an amount of up to 10 mol %, based on the element into whose lattice sites the dopant is incorporated and that replaces it in the compound. If the compound is thus doped, for example, with Eu²⁺ and the Eu²⁺ is incorporated into the lattice sites of alkaline-earth metal ions in the compound, the amount of Eu²⁺ ions, based on the total amount of alkaline-earth metal ions and Eu²⁺ ions, is a maximum of 10%.

In a preferred embodiment of the invention, the compound according to the invention contains precisely one dopant (activator), i.e. is doped either with Eu or with Ce or with Sm or with Pr, where the proportion of the dopant is up to 10 mol %. The proportion is preferably 0.1 to 5 mol %, particularly preferably 0.5 to 2 mol %, very particularly preferably 0.8 to 1.2 mol %.

In a preferred embodiment of the invention, at least one of the indices a, b and c=0. The compound according to the invention thus particularly preferably contains cations from a maximum of two of the three groups A, EA and Ln. The compound according to the invention particularly preferably contains cations from the group EA and/or Ln. a is thus particularly preferably=0.

In a further preferred embodiment of the invention, the indices a, b, c, e, f, g, h and i each stand for integers, where a deviation therefrom is possible for a, b or c if the corresponding cation has in each case been replaced by the doping with Eu or Ce or Sm or Pr.

If the boron-containing unit of the compound according to the invention stands for BN₂, e then preferably stands for 1, 2, 3 or 4, particularly preferably for 2 or 3.

In a preferred embodiment of the invention, Hal=F. In a particularly preferred embodiment, i=0, and the compound according to the invention contains no halide Hal.

Preferred embodiments of the compounds according to the invention in which the boron-containing unit stands for BN₂ are the europium-, cerium-, samarium- or praseodymium-doped compounds of the following formula (2), where the dopant is present in an amount of up to 10 mol %,

(EA)_{b}(Ln)_{b}(BN₂)ₑN_{f}O_{g}(BNO)ₕ formula (2)

where EA and Ln have the meanings given above and the following applies to the indices used:
0≦b≦4, preferably 0≦b≦3;
0≦c≦6, preferably 0≦c≦3;
1≦e≦4;
0≦f≦3, preferably 0≦f≦2, particularly preferably 0≦f≦1;

0≦g≦6, preferably 0≦g≦3;

0≦h≦1;

where the following applies to the indices:

2b+3c=3e+3f+2g+2h;

with the proviso that a maximum of one of indices f, g and h is >0.

Preferred embodiments of the above-mentioned compound of the formula (2) are the compounds (2-Eu) and (2-Ce) and (2-Sm-a) and (2-Sm-b) and (2-Pr),

(EA)_{b-x}(Ln)_{b}(BN₂)ₑN_{f}O_{g}(BNO)ₕ:Euₓ formula (2-Eu)

(EA)_{b}(Ln)_{c-y}(BN₂)ₑN_{f}O_{g}(BNO)ₕ:Ce_{y} formula (2-Ce)

(EA)_{b-x}(Ln)_{c}(BN₂)ₑN_{f}O_{g}(BNO)ₕ:Smₓ formula (2-Sm-a)

(EA)_{b}(Ln)_{c-y}(BN₂)ₑN_{f}O_{g}(BNO)ₕ:Sm_{y} formula (2-Sm-b)

(EA)_{b}(Ln)_{c-y}(BN₂)ₑN_{f}O_{g}(BNO)ₕ:Pr_{y} formula (2-Pr)

where the symbols and indices used have the meanings given for formula (2) and furthermore:
0<x≦0.05;
0<y≦0.05;
b>x in formulae (2-Eu) and (2-Sm-a);
c>y in formulae (2-Ce), (2-Sm-b) and (2-Pr).

Preferred embodiments of the compounds of the formula (2) are the europium-, cerium-, samarium- or praseodymium-doped compounds of the following formulae (2A) to (2R),

(EA)_{4,5}(BN₂)₃ formula (2A)

(EA)₃(BN₂)_{2-f}N_{f} formula (2B)

(Ln)₃(BN₂)₃ formula (2C)

(EA)₃(Ln)₂(BN₂)₄ formula (2D)

(EA)(Ln)₃(BN₂)₃(BNO) formula (2E)

(EA)₃(Ln)₂(BN₂)₂ formula (2F)

(EA)₃(Ln)(BN₂)₃ formula (2G)

(Ln)₃(BN₂)O₃ formula (2H)

A(EA)₄(BN₂)₃ formula (2I)

(EA)₄(BN₂)₂O formula (2J)

(EA)₆BN₅ formula (2K)

A(EA)₄(BN₂)₃ formula (2L)

(EA)₂(BN₂)(Hal) formula (2M)

(Ln)₆(BN₃)O₆ formula (2N)

(Ln)₅(B₄N₉) formula (2O)

(Ln)₆(B₄N₁₀) formula (2P)

(Ln)₄(B₂N₅) formula (2Q)

(Ln)₅(B₂N₆) formula (2R),

where the symbols and indices used have the meanings given above.

The BN₂ units here for f>0, in particular for f=1, in formula (2B) can either be in the form of a separate BN₂ unit together with a separate N or in the form of a 6N₃ unit.

Furthermore, the BN₂ units, for example in formulae (2A), (2B), (2C) and (2G), can either be in the form of three separate BN₂ units or in the form of one B₃N₆ unit. Furthermore, the BN₂ units, for example in formula (2F), can either be in the form of two separate BN₂ units or in the form of one B₂N₄ unit.

Particularly preferred embodiments are the following compounds (2A-Eu) to (2R-Pr),

(EA)_{4,5-x}(BN₂)₃:Euₓ formula (2A-Eu)

(EA)_{4,5}(BN₂)₃:Ce formula (2A-Ce)

(EA)_{4,5-x}(BN₂)₃:Smₓ formula (2A-Sm)

(EA)₃₋ₓ(BN₂)_{2-f}N_{f}:Euₓ formula (2B-Eu)

(EA)₃(BN₂)_{2-f}N_{f}:Ce formula (2B-Ce)

(EA)₃₋ₓ(BN₂)_{2-f}N_{f}:Smₓ formula (2B-Sm)

(Ln)_{3-y}(BN₂)₃:Ce_{y} formula (2C-Ce)

(Ln)_{3-y}(BN₂)₃:Sm_{y} formula (2C-Sm)

(Ln)_{3-y}(BN₂)₃:Pr_{y} formula (2C-Pr)

(EA)₃₋ₓ(Ln)₂(BN₂)₄:Euₓ formula (2D-Eu)

(EA)₃₋ₓ(Ln)₂(BN₂)₄:Smₓ formula (2D-Sm-a)

(EA)₃(Ln)_{2-y}(BN₂)₄:Ce_{y} formula (2D-Ce)

(EA)₃(Ln)_{2-y}(BN₂)₄:Sm_{y} formula (2D-Sm-b)

(EA)₃(Ln)_{2-y}(BN₂)₄:Pr_{y} formula (2D-Pr)

(EA)₁₋ₓ(Ln)₃(BN₂)₃(BNO):Euₓ formula (2E-Eu)

(EA)₁₋ₓ(Ln)₃(BN₂)₃(BNO):Smₓ formula (2E-Sm-a)

(EA)(Ln)_{3-y}(BN₂)₃(BNO):Ce_{y} formula (2E-Ce)

(EA)(Ln)_{3-y}(BN₂)₃(BNO):Sm_{y} formula (2E-Sm-b)

(EA)(Ln)_{3-y}(BN₂)₃(BNO):Pr_{y} formula (2E-Pr)

(EA)₃₋ₓ(Ln)₂(BN₂)₂:Euₓ formula (2F-Eu)

(EA)₃₋ₓ(Ln)₂(BN₂)₂:Smₓ formula (2F-Sm-a)

(EA)₃(Ln)_{2-y}(BN₂)₂:Ce_{y} formula (2F-Ce)

(EA)₃(Ln)_{2-y}(BN₂)₂:Sm_{y} formula (2F-Sm-b)

(EA)₃(Ln)_{2-y}(BN₂)₂:Pr_{y} formula (2F-Pr)

(EA)₃₋ₓ(Ln)(BN₂)₃:Euₓ formula (2G-Eu)

(EA)₃₋ₓ(Ln)(BN₂)₃:Smₓ formula (2G-Sm-a)

(EA)₃(Ln)_{1-y}(BN₂)₃:Ce_{y} formula (2G-Ce)

(EA)₃(Ln)_{1-y}(BN₂)₃:Sm_{y} formula (2G-Sm-b)

(EA)₃(Ln)_{1-y}(BN₂)₃:Pr_{y} formula (2G-Pr)

(Ln)_{3-y}(BN₂)O₃:Ce_{y} formula (2H-Ce)

(Ln)_{3-y}(BN₂)O₃:Sm_{y} formula (2H-Sm)

(Ln)_{3-y}(BN₂)O₃:Pr_{y} formula (2H-Pr)

A(EA)₄(BN₂)₃:Euₓ formula (2I-Eu)

A(EA)₄₋ₓ(BN₂)₃:Smₓ formula (2I-Sm)

(EA)₄₋ₓ(BN₂)₂O:Euₓ formula (2J-Eu)

(EA)₄₋ₓ(BN₂)₂O:Smₓ formula (2J-Sm)

(EA)₆₋ₓ,BN₅:Euₓ formula (2K-Eu)

(EA)₆₋ₓ,BN₅:Smₓ formula (2K-Sm)

A(EA)₄₋ₓ(BN₂)₃:Euₓ formula (2L-Eu)

A(EA)₄₋ₓ(BN₂)₃:Smₓ formula (2L-Sm)

(EA)₂₋ₓ(BN₂)(Hal):Euₓ formula (2M-Eu)

(EA)₂₋ₓ(BN₂)(Hal):Smₓ formula (2M-Sm)

(Ln)_{6-y}(BN₃)O₆:Ce_{y} formula (2N-Ce)

(Ln)_{6-y}(BN₃)O₆:Sm_{y} formula (2N-Sm)

(Ln)_{6-y}(BN₃)O₆:Pr_{y} formula (2N-Pr)

(Ln)_{5-y}(B₄N₉):Ce_{y} formula (2O-Ce)

(Ln)_{5-y}(B₄N₉):Sm_{y} formula (2O-Sm)

(Ln)_{5-y}(B₄N₉):Pr_{y} formula (2O-Pr)

(Ln)_{6-y}(B₄N₁₀):Ce_{y} formula (2P-Ce)

(Ln)_{6-y}(B₄N₁₀):Sm_{y} formula (2P-Sm)

(Ln)_{6-y}(B₄N₁₀):Pr_{y} formula (2P-Pr)

(Ln)_{4-y}(B₂N₅):Ce_{y} formula (2Q-Ce)

(Ln)_{4-y}(B₂N₅):Sm_{y} formula (2Q-Sm)

(Ln)_{4-y}(B₂N₅):Pr_{y} formula (2Q-Pr)

(Ln)_{5-y}(B₂N₆):Ce_{y} formula (2R-Ce)

(Ln)_{5-y}(B₂N₆):Sm_{y} formula (2R-Sm)

(Ln)_{5-y}(B₂N₆):Pr_{y} formula (2R-Pr),

where the symbols and indices used have the meanings given above.

In a preferred embodiment of the compounds of the formula (2B) or the preferred embodiments, f=0. In a further preferred embodiment of the compounds of the formula (2B) or the preferred embodiments, f=1.

If the compounds according to the invention contain alkali metals A, A is preferably selected, identically or differently, from Li and Na, particularly preferably Li.

If the compounds according to the invention contain alkaline-earth metals EA, EA is preferably selected, identically or differently, from Ca, Sr and Ba, particularly preferably Sr and Ba. The compound of the formula (2A) is preferably Sr_{0.5}Ba₄(BN₂)₃ with Eu, Ce, Sm or Pr doping.

If the compounds according to the invention contain rare-earth metals Ln, Ln is preferably selected, identically or differently, from Y, Lu and Gd.

If the compounds according to the invention contain halogens Hal, Hal is preferably selected, identically or differently, from F and Cl, particularly preferably F.

The compounds according to the invention can be in the form of a pure phase or in the form of a mixed phase with other phases. A foreign phase which may arise during the synthesis and does not have an adverse effect on the properties of the compounds according to the invention comprises alkaline-earth metal oxides.

The compounds according to the invention can be prepared by mixing suitable starting materials and calcination, in particular under non-oxidising conditions, preferably under reducing conditions.

The present invention therefore furthermore relates to a process for the preparation of a compound according to the invention, characterised by the following process steps:
(a) preparation of a mixture comprising a nitride of one or more of the cations A, EA and/or Ln, where the symbols have the meanings given above, in addition boron nitride BN and a europium, cerium, samarium and/or praseodymium source;
(b) calcination of the mixture under non-oxidising conditions.

The europium source employed in step (a) can be any conceivable europium compound with which a europium-doped boronitride can be prepared. The europium source employed is preferably europium oxide (especially Eu₂O₃) and/or europium nitride (EuN), in particular EuN.

The cerium source employed in step (a) can be any conceivable cerium compound with which a cerium-doped boronitride can be prepared. The cerium source employed is preferably cerium oxide (especially CeO₂) and/or cerium nitride (CeN), in particular CeN.

Suitable starting materials for the elements A, EA, Ln, Sm and/or Pr are the corresponding nitrides, hydrides or also the free metals. If the compounds according to the invention contain Hal, the corresponding halides can also be employed. For the preparation of the oxyboronitrides, the oxides, borates and carbonates can also be employed.

The compounds are preferably employed in a ratio to one another such that the number of atoms of the elements A, EA and/or Ln, of europium, cerium, samarium and/or praseodymium, of boron, of nitrogen and of oxygen essentially corresponds to the desired ratio in the product in the said formulae. In particular, a stoichiometric ratio is used here.

The starting compounds in step (a) are preferably employed in powder form and are processed with one another, for example by means of a mortar, to give a homogeneous mixture. Since the nitrides used are moisture-sensitive, the preparation of the mixtures is preferably carried out in an inert atmosphere, for example under protective gas in a glove box.

The calcination in step (b) is carried out under non-oxidising conditions. Non-oxidising conditions are taken to mean any conceivable non-oxidising atmospheres, in particular substantially oxygen-free atmospheres, i.e. an atmosphere whose maximum oxygen content is <100 ppm, in particular <10 ppm, where vacuum is not suitable as non-oxidising atmosphere in the present case. A non-oxidising atmosphere can be generated, for example, through the use of protective gas, in particular nitrogen or argon. A preferred non-oxidising atmosphere is a reducing atmosphere. The reducing atmosphere is defined as comprising at least one gas with a reducing action. What gases have a reducing action is known to the person skilled in the art. Examples of suitable reducing gases are hydrogen, carbon monoxide, ammonia and ethylene, more preferably hydrogen, where these gases may also be mixed with other non-oxidising gases. The reducing atmosphere is particularly preferably generated by a mixture of nitrogen and hydrogen, preferably in the H₂:N₂ ratio of 1:99 to 20:80, preferably 3:97 to 10:90, in each case based on the volume.

The calcination is preferably carried out at a temperature in the range from 900° C. to 2000° C., particularly preferably 1000° C. to 1700° C., very particularly preferably from 1000° C. to 1400° C.

The calcination duration here is preferably 1 to 14 h, particularly preferably 2 to 12 h and in particular 5 to 10 h.

The calcination is preferably carried out by introducing the mixtures obtained, for example, into a high-temperature oven in a boron nitride vessel. The high-temperature oven is, for example, a tubular furnace which contains a molybdenum foil tray.

After preparation, the phosphors obtained in this way are usually deagglomerated and sieved.

In a further embodiment, the compounds according to the invention may be coated. Suitable for this purpose are all coating methods as are known to the person skilled in the art in accordance with the prior art and are used for phosphors. Suitable materials for the coating are, in particular, metal oxides and nitrides, in particular alkaline-earth metal oxides, such as Al₂O₃, and alkaline-earth metal nitrides, such as AlN, as well as SiO₂. The coating here can be carried out, for example, by fluidised-bed methods. Further suitable coating methods are known from JP 04-304290, WO 91/10715, WO 99/27033, US 2007/0298250, WO 2009/065480 and WO 2010/075908. It is also possible to apply an organic coating as an alternative and/or in addition to the above-mentioned inorganic coating.

The present invention furthermore relates to the use of the compound according to the invention as phosphor, in particular as conversion phosphor.

The term “conversion phosphor” in the sense of the present application is taken to mean a material which absorbs radiation in a certain wavelength region of the electromagnetic spectrum, preferably in the blue or UV spectral region, and emits visible light in another wavelength region of the electromagnetic spectrum, preferably in the red or orange spectral region, in particular in the red spectral region. The term “radiation-induced emission efficiency” should also be understood in this connection, i.e. the conversion phosphor absorbs radiation in a certain wavelength region and emits radiation with a certain efficiency in another wavelength region. The term “shift of the emission wavelength” is taken to mean that a conversion phosphor emits light at a different wavelength, i.e. shifted to a shorter or longer wavelength, compared with another or similar conversion phosphor. The emission maximum is thus shifted.

The present invention furthermore relates to an emission-converting material comprising a compound of one of the above-mentioned formulae according to the invention. The emission-converting material may consist of the compound according to the invention and would in this case be equivalent to the term “conversion phosphor” defined above.

It is also possible for the emission-converting material according to the invention to comprise further conversion phosphors besides the compound according to the invention. In this case, the emission-converting material according to the invention comprises a mixture of at least two conversion phosphors, where one of these is a compound according to the invention. It is particularly preferred for the at least two conversion phosphors to be phosphors which emit light of different wavelengths which are complementary to one another. If the compound according to the invention is a red-emitting phosphor, this is preferably employed in combination with a green- or yellow-emitting phosphor or also with a cyan- or blue-emitting phosphor. Alternatively, the red-emitting conversion phosphor according to the invention can also be employed in combination with (a) blue- and green-emitting conversion phosphor(s). Alternatively, the red-emitting conversion phosphor according to the invention can also be employed in combination with (a) green-emitting conversion phosphor(s). It may thus be preferred for the conversion phosphor according to the invention to be employed in the emission-converting material according to the invention in combination with one or more further conversion phosphors, which then together preferably emit white light.

In the context of this application, blue light denotes light whose emission maximum lies between 400 and 459 nm, cyan light denotes light whose emission maximum lies between 460 and 505 nm, green light denotes light whose emission maximum lies between 506 and 545 nm, yellow light denotes light whose emission maximum lies between 546 and 565 nm, orange light denotes light whose emission maximum lies between 566 and 600 nm and red light denotes light whose emission maximum lies between 601 and 670 nm. The compound according to the invention is preferably a red-emitting conversion phosphor.

In general, any possible conversion phosphor can be employed as a further conversion phosphor which can be employed together with the compound according to the invention. The following, for example, are suitable here: Ba₂SiO₄:Eu²⁺, BaSi₂O₆:Pb²⁺, BaₓSr₁₋ₓF₂:Eu²⁺, BaSrMgSi₂O₇:Eu²⁺, BaTiP₂O₇, (Ba, Ti)₂P₂O₇:Ti, Ba₃WO₆:U, BaY₂F₈:Er³⁺,Yb⁺, Be₂SiO₄:Mn²⁺, Bi₄Ge₃O₁₂, CaAl₂O₄:Ce³⁺, CaLa₄O₇:Ce³⁺, CaAl₂O₄:El²⁺, CaAl₂O₄:Mn²⁺, CaAl₄O₇:Pb²⁺, Mn²⁺, CaAl₂O₄:Tb³⁺, Ca₃Al₂Si₃O₁₂:Ce³⁺, Ca₃Al₂Si₃Oi₂:Ce³⁺, Ca₃Al₂Si₃O₂:El²⁺, Ca₂B₅O₉Br:Eu²⁺, Ca₂B₅O₉Cl:Eu²⁺, Ca₂B₅O₉Cl:Pb²⁺, CaB₂O₄:Mn²⁺, Ca₂B₂O₅:Mn²⁺, CaB₂O₄:Pb²⁺, CaB₂P₂O₉:El²⁺, Ca₅B₂SiO₁₀:Eu³⁺, Ca_{0.5}Ba_{0.5}Al₁₂O₁₉:Ce³⁺,Mn²⁺, Ca₂Ba₃(PO₄)₃Cl:Eu²⁺, CaBr₂:Eu²⁺ in SiO₂, CaCl₂:Eu²⁺ in SiO₂, CaCl₂:Eu²⁺,Mn²⁺ in SiO₂, CaF₂:Ce³⁺, CaF₂:Ce³⁺,Mn²⁺, CaF₂:Ce³⁺,Tb³⁺, CaF₂:Eu²⁺, CaF₂:Mn²⁺, CaF₂:U, CaGa₂O₄:Mn²⁺, CaGa₄O₇:Mn²⁺, CaGa₂S₄:Ce³⁺, CaGa₂S₄:Eu²⁺, CaGa₂S₄:Mn²⁺, CaGa₂S₄:Pb²⁺, CaGeO₃:Mn²⁺, CaI₂:Eu²⁺ in SiO₂, CaI₂:Eu²⁺,Mn²⁺ in SiO₂, CaLaBO₄:Eu³⁺, CaLaB₃O₇:Ce³⁺,Mn²⁺, Ca₂La₂BO_{6.6}:Pb²⁺, Ca₂MgSi₂O₇, Ca₂MgSi₂O₇:Ce³⁺, CaMgSi₂O₆:Eu²⁺, Ca₃MgSi₂O₈:Eu²⁺, Ca₂MgSi₂O₇:Eu²⁺, CaMgSi₂O₆:Eu²⁺,Mn²⁺, Ca₂MgSi₂O₇:Eu²⁺,Mn²⁺, CaMoO₄, CaMoO₄:Eu³⁺, CaO:Bi³⁺, CaO:Cd²⁺, CaO:Cut, CaO:Eu³⁺, CaO:Eu³⁺, Nat, CaO:Mn²⁺, CaO:Pb²⁺, CaO:Sb³⁺, CaO:Sm³⁺, CaO:Tb³⁺, CaO:Tl, CaO:Zn²⁺, Ca₂P₂O₇:Ce³⁺, α-Ca₃(PO₄)₂:Ce³⁺, β-ca₃(PO₄)₂:ce³⁺, Ca₆(PO₄)₃Cl:Eu²⁺, Ca₆(PO₄)₃Cl:Mn²⁺, Ca₆(PO₄)₃Cl:Sb³⁺, Ca₆(PO₄)₃Cl:Sn²⁺, β-Ca₃(PO₄)₂:Eu²⁺,Mn²⁺, Ca₆(PO₄)₃F:Mn²⁺, Ca₅(PO₄)₃F:Sb³⁺, Ca₅(PO₄)₃F:Sn²⁺, α-Ca₃(PO₄)₂:Eu²⁺, β-Ca₃(PO₄)₂:Eu²⁺, Ca₂P₂O₇:Eu²⁺, Ca₂P₂O₇:Eu²⁺,Mn²⁺, CaP₂O₆:Mn²⁺, α-Ca₃(PO₄)₂:Pb²⁺, α-Ca₃(PO₄)₂:Sn²⁺, β-Ca₃(PO₄)₂:Sn²⁺, β-Ca₂P₂O₇:Sn,Mn, α-Ca₃(PO₄)₂:Tr, CaS:Bi³⁺, CaS:Bi³⁺,Na, CaS:Ce³⁺, CaS:Eu²⁺, CaS:Cut,Nat, CaS:La³⁺, CaS:Mn²⁺, CaSO₄:Bi, CaSO₄:Ce³⁺, CaSO₄:Ce³⁺,Mn²⁺, CaSO₄:Eu²⁺, CaSO₄:Eu²⁺,Mn²⁺, CaSO₄:Pb²⁺, CaS:Pb²⁺, CaS:Pb²⁺,Cl, CaS:Pb²⁺,Mn²⁺, CaS:Pr³⁺,Pb²⁺,Cl, CaS:Sb³⁺, CaS:Sb³⁺,Na, CaS:Sm³⁺, CaS:Sn²⁺, CaS:Sn²⁺,F, CaS:Tb³⁺, CaS:Tb³⁺,Cl, CaS:Y³⁺, CaS:Yb²⁺, CaS:Yb²⁺,Cl, CaSiO₃:Ce³⁺, Ca₃SiO₄Cl₂:El²⁺, Ca₃SiO₄Cl₂:Pb²⁺, CaSiO₃:El²⁺, CaSiO₃:Mn²⁺,Pb, CaSiO₃:Pb²⁺, CaSiO₃:Pb²⁺,Mn²⁺, CaSiO₃:Ti⁴⁺, CaSr₂(PO₄)₂:Bi³⁺, β-(Ca,Sr)₃(PO₄)₂:Sn²⁺Mn²⁺, CaTi_{0.9}Al_{0.1}O₃:Bi³⁺, CaTiO₃:Eu³⁺, CaTiO₃:Pr³⁺, Ca₆(VO₄)₃Cl, CaWO₄, CaWO₄:Pb²⁺, CaWO₄:W, Ca₃WO₆:U, CaYAlO₄:Eu³⁺, CaYBO₄:Bi³⁺, CaYBO₄:Eu³⁺, CaYB_{0.8}O_{3.7}:Eu³⁺, CaY₂ZrO₆:Eu³⁺, (Ca,Zn,Mg)₃(PO₄)₂:Sn, CeF₃, (Ce,Mg)BaAl₁₁O₁₈:Ce, (Ce,Mg)SrAl₁₁O₁₈:Ce, CeMgAl₁₁O₁₉:Ce:Tb, Cd₂B₆O₁₁:Mn²⁺, CdS:Ag⁺,Cr, CdS:In, CdS:In, CdS:In,Te, CdS:Te, CdWO₄, CsF, CsI, CsI:Na⁺, CsI:Tl, (ErCl₃)_{0.26}(BaCl₂)_{0.75}, GaN:Zn, Gd₃Ga₆O₁₂:Cr³⁺, Gd₃Ga₅O₁₂:Cr,Ce, GdNbO₄:Bi³⁺, Gd₂O₂S:Eu³⁺, Gd₂O₂Pr³⁺, Gd₂O₂S:Pr,Ce,F, Gd₂O₂S:Tb³⁺, Gd₂SiO₆:Ce³⁺, KAl₁₁O₁₇:Tl⁺, KGa₁₁O₁₇:Mn²⁺, K₂La₂Ti₃O₁₀:Eu, KMgF₃:Eu²⁺, KMgF₃:Mn²⁺, K₂SiF₆:Mn⁴⁺, LaAl₃B₄O₁₂:Eu³⁺, LaAlB₂O₆:Eu³⁺, LaAlO₃:Eu³⁺, LaAlO₃:Sm³⁺, LaAsO₄:Eu³⁺, LaBr₃:Ce³⁺, LaBO₃:Eu³⁺, (La,Ce,Tb)PO₄:Ce:Tb, LaCl₃:Ce³⁺, La₂O₃:Bi³⁺, LaOBr:Tb³⁺, LaOBr:Tm³⁺, LaOCl:Bi³⁺, LaOCl:Eu³⁺, LaOF:Eu³⁺, La₂O₃:Eu³⁺, La₂O₃:Pr³⁺, La₂O₂S:Tb³⁺, LaPO₄:Ce³⁺, LaPO₄:Eu³⁺, LaSiO₃Cl:Ce³⁺, LaSiO₃Cl:Ce³⁺,Tb³⁺, LaVO₄:Eu³⁺, La₂W₃O₁₂:Eu³⁺, LiAlF₄:Mn²⁺, LiAl₅O₈:Fe³⁺, LiAlO₂:Fe³⁺, LiAlO₂:Mn²⁺, LiAl₅O₈:Mn²⁺, Li₂CaP₂O₇:Ce³⁺,Mn²⁺, LiCeBa₄Si₄O₁₄:Mn²⁺, LiCeSrBa₃Si₄O₁₄:Mn²⁺, LiInO₂:Eu³⁺, LiInO₂:Sm³⁺, LiLaO₂:Eu³⁺, LuAlO₃:Ce³⁺, (Lu,Gd)₂SiO₅:Ce³⁺, Lu₂SiO₅:Ce³⁺, Lu₂Si₂O₇:Ce³⁺, LuTaO₄:Nb⁵⁺, Lu₁₋ₓYₓAlO₃:Ce³⁺, MgAl₂O₄:Mn²⁺, MgSrAl₁₀O₁₇:Ce, MgB₂O₄:Mn²⁺, MgBa₂(PO₄)₂:Sn²⁺, MgBa₂(PO₄)₂:U, MgBaP₂O₇:Eu²⁺, MgBaP₂O₇:Eu²⁺,Mn²⁺, MgBa₃Si₂O₈:Eu²⁺, MgBa(SO₄)₂:Eu²⁺, Mg₃Ca₃(PO₄)₄:Eu²⁺, MgCaP₂O₇:Mn²⁺, Mg₂Ca(SO₄)₃:Eu²⁺, Mg₂Ca(SO₄)₃:Eu²⁺,Mn², MgCeAlₙO₁₉:Tb³⁺, Mg₄(F)GeO₆:Mn²⁺, Mg₄(F)(Ge,Sn)O₆:Mn²⁺, MgF₂:Mn²⁺, MgGa₂O₄:Mn²⁺, Mg₈Ge₂Oᵢᵢ F₂:Mn⁴⁺, MgS:Eu²⁺, MgSiO₃:Mn²⁺, Mg₂SiO₄:Mn²⁺, Mg₃SiO₃F₄:Ti⁴⁺, MgSO₄:Eu²⁺, MgSO₄:Pb²⁺, MgSrBa₂Si₂O₇:Eu²⁺, MgSrP₂O₇:Eu²⁺, MgSr₅(PO₄)₄:Sn²⁺, MgSr₃Si₂O₈:Eu²⁺,Mn²⁺, Mg₂Sr(SO₄)₃:Eu²⁺, Mg₂TiO₄:Mn⁴⁺, MgWO₄, MgYBO₄:Eu³⁺, Na₃Ce(PO₄)₂:Tb³⁺, NaI:Tl, Na_{1.23}K_{0.42}Eu_{0.12}TiSi₄O₁₁:Eu³⁺, Na_{1.23}K_{0.42}Eu_{0.12}TiSi₅O₁₃.xH₂O:Eu³⁺, Na_{1.29}K_{0.46}Er_{0.08}TiSi₄O₁₁:Eu³⁺, Na₂Mg₃Al₂Si₂O₁₀:Tb, Na(Mg₂Mnₓ)LiSi₄O₁₀F₂:Mn, NaYF₄:Er³⁺, Yb³⁺, NaYO₂:Eu³⁺, P46(70%)+P47 (30%), SrAl₁₂O₁₉:Ce³⁺, Mn²⁺, SrAl₂O₄:Eu²⁺, SrAl₄O₇:Eu³⁺, SrAl₁₂O₁₉:Eu²⁺, SrAl₂S₄:Eu²⁺, Sr₂B₅O₉Cl:Eu²⁺, SrB₄O₇:Eu²⁺(F,Cl,Br), SrB₄O₇:Pb²⁺, SrB₄O₇:Pb²⁺, Mn²⁺, SrB₈O₁₃:Sm²⁺, SrₓBa_{y}Cl_{z}Al₂O_{4-z/2}: Mn²⁺, Ce³⁺, SrBaSiO₄:Eu²⁺, Sr(Cl,Br,I)₂:Eu²⁺ in SiO₂, SrCl₂:Eu²⁺ in SiO₂, Sr₅Cl(PO₄)₃:Eu, Sr_{w}FₓB₄O_{6.5}:Eu²⁺, Sr_{w}FₓB_{y}O_{z}:Eu²⁺,Sm²⁺, SrF₂:Eu²⁺, SrGa₁₂O₁₉:Mn²⁺, SrGa₂S₄:Ce³⁺, SrGa₂S₄:Eu²⁺, SrGa₂S₄:Pb²⁺, SrIn₂O₄:Pr³⁺, Al³⁺, (Sr,Mg)₃(PO₄)₂:Sn, SrMgSi₂O₆:Eu²⁺, Sr₂MgSi₂O₇:Eu²⁺, Sr₃MgSi₂O₈:Eu²⁺, SrMoO₄:U, SrO.3B₂O₃:Eu²⁺,Cl, β-srO.3B₂O₃:Pb²⁺, β-SrO.3B₂O₃:Pb²⁺,Mn²⁺, α-SrO.3B₂O₃:Sm²⁺, Sr₆P₅BO₂₀:Eu, Sr₅(PO₄)₃Cl:Eu²⁺, Sr₅(PO₄)₃Cl:Eu²⁺,Pr³⁺, Sr₅(PO₄)₃Cl:Mn²⁺, Sr₅(PO₄)₃Cl:Sb³⁺, Sr₂P₂O₇:Eu²⁺, β-Sr₃(PO₄)₂:Eu²⁺, Sr₅(PO₄)₃F:Mn²⁺, Sr₅(PO₄)₃F:Sb³⁺, Sr₅(PO₄)₃F:Sb³⁺,Mn²⁺, Sr₅(PO₄)₃F:Sn²⁺, Sr₂P₂O₇:Sn²⁺, β-Sr₃(PO₄)₂:Sn²⁺, β-Sr₃(PO₄)₂:Sn²⁺,Mn²⁺(Al), SrS:Ce³⁺, SrS:Eu²⁺, SrS:Mn²⁺, SrS:Cu⁺,Na, SrSO₄:Bi, SrSO₄:Ce³⁺, SrSO₄:Eu²⁺, SrSO₄:Eu²⁺,Mn²⁺, Sr₅Si₄O₁₀Cl₆:Eu²⁺, Sr₂SiO₄:Eu²⁺, SrTiO₃:Pr³⁺, SrTiO₃:Pr³⁺,Al³⁺, Sr₃WO₆:U, SrY₂O₃:Eu³⁺, ThO₂:Eu³⁺, ThO₂:Pr³⁺, ThO₂:Tb³⁺, YAl₃B₄O₁₂:Bi³⁺, YAl₃B₄O₁₂:Ce³⁺, YAl₃B₄O₁₂:Ce³⁺,Mn, YAl₃B₄O₁₂:Ce³⁺,Tb³⁺, YAl₃B₄O₁₂:Eu³⁺, YAl₃B₄O₁₂:Eu³⁺,Cr³⁺, YAl₃B₄O₁₂:Th⁴⁺,Ce³⁺,Mn²⁺, YAlO₃:Ce³⁺, Y₃Al₅O₁₂:Ce³⁺, Y₃Al₅O₁₂:Cr³⁺, YAlO₃:Eu³⁺, Y₃Al₅O₁₂:Eu^{3r}, Y₄Al₂O₉:Eu³⁺, Y₃Al₅O₁₂:Mn⁴⁺, YAlO₃:Sm³⁺, YAlO₃:Tb³⁺, Y₃Al₅O₁₂:Tb³⁺, YAsO₄:Eu³⁺, YBO₃:Ce³⁺, YBO₃:Eu³⁺, YF₃:Er³⁺,Yb³⁺, YF₃:Mn²⁺, YF₃:Mn²⁺,Th⁴⁺, YF₃:Tm³⁺,Yb³⁺, (Y,Gd)BO₃:Eu, (Y,Gd)BO₃:Tb, (Y,Gd)₂O₃:Eu³⁺, Y_{1.34}Gd_{0.60}O₃(Eu,Pr), Y₂O₃:Bi³⁺, YOBrEu³⁺, Y₂O₃:Ce, Y₂O₃:Er³⁺, Y₂O₃:Eu³⁺(YOE), Y₂O₃:Ce³⁺,Tb³⁺, YOCl:Ce³⁺, YOCl:Eu³⁺, YOF:Eu³⁺, YOF:Tb³⁺, Y₂O₃:Ho³⁺, Y₂O₂S:Eu³⁺, Y₂O₂S:Pr³⁺, Y₂O₂S:Tb³⁺, Y₂O₃:Tb³⁺, YPO₄:Ce³⁺, YPO₄:Ce³⁺,Tb³⁺, YPO₄:Eu³⁺, YPO₄:Mn²⁺,Th⁴⁺, YPO₄:V⁵⁺, Y(P,V)O₄:Eu, Y₂SiO₅:Ce³⁺, YTaO₄, YTaO₄:Nb⁵⁺, YVO₄:Dy³⁺, YVO₄:Eu³⁺, ZnAl₂O₄:Mn²⁺, ZnB₂O₄:Mn²⁺, ZnBa₂S₃:Mn²⁺, (Zn,Be)₂SiO₄:Mn²⁺, Zn_{0.4}Cd_{0.6}S:Ag, Zn_{0.6}Cd_{oA}S:Ag, (Zn,Cd)S:Ag,Cl, (Zn,Cd)S:Cu, ZnF₂:Mn²⁺, ZnGa₂O₄, ZnGa₂O₄:Mn²⁺, ZnGa₂S₄:Mn²⁺, Zn₂GeO₄:Mn²⁺, (Zn,Mg)F₂:Mn²⁺, ZnMg₂(PO₄)₂:Mn²⁺, (Zn,Mg)₃(PO₄)₂:Mn²⁺, ZnO:Al³⁺,Ga³⁺, ZnO:Bi³⁺, ZnO:Ga³⁺, ZnO:Ga, ZnO—CdO:Ga, ZnO:S, ZnO:Se, ZnO:Zn, ZnS:Ag⁺,Cl⁻, ZnS:Ag,Cu,Cl, ZnS:Ag,Ni, ZnS:Au,In, ZnS—CdS (25-75), ZnS—CdS (50-50), ZnS—CdS (75-25), ZnS—CdS:Ag,Br,Ni, ZnS—CdS:Ag⁺,Cl, ZnS—CdS:Cu,Br, ZnS—CdS:Cu,I, ZnS:Cl⁻, ZnS:Eu²⁺, ZnS:Cu, ZnS:Cu⁺,Al³⁺, ZnS:Cu⁺,Cl⁻, ZnS:Cu,Sn, ZnS:Eu²⁺, ZnS:Mn²⁺, ZnS:Mn,Cu, ZnS:Mn²⁺,Te²⁺, ZnS:P, ZnS:Pb²⁺, ZnS:Pb²⁺,Cl⁻, ZnS:Pb,Cu, Zn₃(PO₄)₂:Mn²⁺, Zn₂SiO₄:Mn²⁺, Zn₂SiO₄:Mn²⁺,As⁵⁺, Zn₂SiO₄:Mn,Sb₂O₂, Zn₂SiO₄:Mn²⁺,P, Zn₂SiO₄:Ti⁴⁺, ZnS:Sn²⁺, ZnS:Sn,Ag, ZnS:Sn²⁺,Li+, ZnS:Te,Mn, ZnS—ZnTe:Mn²⁺, ZnSe:Cu⁺,Cl or ZnWO₄.

The present invention furthermore relates to the use of the emission-converting material according to the invention in a light source. The light source is particularly preferably an LED, in particular a phosphor-converted LED, pc-LED for short. It is particularly preferred here for the emission-converting material to comprise at least one further conversion phosphor besides the conversion phosphor according to the invention, in particular so that the light source emits white light or light having a certain colour point (colour-on-demand principle). The “colour-on-demand principle” is taken to mean the achievement of light having a certain colour point with a pc-LED using one or more conversion phosphors.

The present invention thus furthermore relates to a light source which comprises a primary light source and the emission-converting material.

Here too, it is particularly preferred for the emission-converting material to comprise at least one further conversion phosphor besides the conversion phosphor according to the invention, so that the light source preferably emits white light or light having a certain colour point.

The light source according to the invention is preferably a pc-LED. A pc-LED generally comprises a primary light source and an emission-converting material. The emission-converting material according to the invention can for this purpose either be dispersed in a resin (for example epoxy or silicone resin) or, given suitable size ratios, arranged directly on the primary light source or alternatively, depending on the application, remote therefrom (the latter arrangement also includes “remote phosphor technology”).

The primary light source can be a semiconductor chip, a luminescent light source, such as ZnO, a so-called TCO (transparent conducting oxide), a ZnSe- or SiC-based arrangement, an arrangement based on an organic light-emitting layer (OLED) or a plasma or discharge source, most preferably a semiconductor chip. If the primary light source is a semiconductor chip, it is preferably a luminescent indium aluminium gallium nitride (InAlGaN), as is known from the prior art. Possible forms of primary light sources of this type are known to the person skilled in the art. Furthermore, lasers are suitable as light source.

For use in light sources, in particular pc-LEDs, the emission-converting material according to the invention can also be converted into any desired outer shapes, such as spherical particles, flakes and structured materials and ceramics. These shapes are summarised under the term “shaped bodies”. The shaped bodies are consequently emission-converting shaped bodies.

The invention furthermore relates to a lighting unit which comprises at least one light source according to the invention. Lighting units of this type are employed principally in display devices, in particular liquid-crystal display devices (LC displays) with backlighting. The present invention therefore also relates to a display device of this type.

In the lighting unit according to the invention, the optical coupling between the emission-converting material and the primary light source (in particular semiconductor chips) preferably takes place by means of a light-conducting arrangement. In this way, it is possible for the primary light source to be installed at a central location and for this to be optically coupled to the emission-converting material by means of light-conducting devices, such as, for example, optical fibres. In this way, it is possible to achieve lamps adapted to the lighting wishes which consist of one or more different conversion phosphors, which may be arranged to form a light screen, and an optical waveguide, which is coupled to the primary light source. In this way, it is possible to place a strong primary light source at a location which is favourable for electrical installation and to install lamps comprising emission-converting materials, which are coupled to the optical waveguides, without further electrical cabling, merely by laying optical waveguides at any desired locations.

The following examples and figures are intended to illustrate the present invention. However, they should in no way be regarded as limiting.

### EXAMPLES

### General Procedure for the Measurement of the Emission

The powder emission spectra are measured by the following general method: a loose phosphor powder bed having a depth of 5 mm whose surface has been smoothed using a glass plate is irradiated at a wavelength of 450 nm in the integration sphere of an Edinburgh Instruments FL 920 fluorescence spectrometer having a xenon lamp as excitation light source, and the intensity of the emitted fluorescence radiation is measured in a range from 465 nm to 800 nm in 1 nm steps.

### Example 1: Mg₃(BN₂)N:Eu²⁺ (1%)

2.3982 g (23.76 mmol) of Mg₃N₂, 0.5903 g (23.79 mmol) of BN and 0.0118 g (0.07 mmol) of EuN are thoroughly mixed with one another in a glove box. The resultant mixture is transferred into a BN crucible and heated at 1100° C. for 6 h under a mixture of N₂/H₂ (95%/5%).

### Example 2: Ca₃(BN₂)₂:Eu²⁺ (1%)

2.2175 g (14.96 mmol) of Ca₃N₂, 0.7642 g (30.07 mmol) of BN and 0.0374 g (0.23 mmol) of EuN are thoroughly mixed with one another in a glove box. The resultant mixture is transferred into a BN crucible and heated at 1600° C. for 8 h under a mixture of N₂/H₂ (95%/5%).

### Example 3: Sr₃(BN₂)₂: Eu²⁺ (1%)

2.5228 g (8.67 mmol) of Sr₃N₂, 0.4348 g (17.52 mmol) of BN and 0.0405 g (0.26 mmol) of EuH₂ are triturated intimately in a mortar. The starting-material mixture is subsequently transferred into a BN crucible and heated at 800° C. for 8 h under N₂/H₂. All manipulations of the starting materials are carried out in an N₂-filled glove box.

### Example 4: SrBa₈(BN₂)₆: Ce³⁺ (1%)

0.2028 g (0.70 mmol) of Sr₃N₂, 2.4794 g (5.63 mmol) of Ba₃N₂, 0.3147 g (12.68 mmol) of BN and 0.0033 g (0.02 mmol) of CeN are triturated intimately in a mortar. The starting-material mixture is subsequently transferred into a BN crucible and heated at 1000° C. for 8 h under N₂/H₂. All manipulations of the starting materials are carried out in an N₂-filled glove box.

### Example 5: SrBa₈(BN₂)₆: Pr³⁺ (1%)

0.2028 g (0.70 mmol) of Sr₃N₂, 2.4793 g (5.63 mmol) of Ba₃N₂, 0.3147 g (12.68 mmol) of BN and 0.0033 g (0.02 mmol) of PrN are triturated intimately in a mortar. The starting-material mixture is subsequently transferred into a BN crucible and heated at 1000° C. for 8 h under N₂/H₂. All manipulations of the starting materials are carried out in an N₂-filled glove box.

### Example 6: SrBN₂F: Eu²⁺ (1%)

1.2288 g (4.22 mmol) of Sr₃N₂, 0.2118 g (8.53 mmol) of BN, 0.0283 g (0.17 mmol) of EuN and 0.5360 g (4.27 mmol) of SrF₂ are triturated intimately in a mortar. The starting-material mixture is subsequently transferred into a BN crucible and heated at 900° C. for 6 h under N₂/H₂. All manipulations of the starting materials are carried out in an N₂-filled glove box.

### Example 7: LED Examples

General Procedure for the Construction and Measurement of pcLEDs

A mass mₚ (in g) of the phosphor shown in the respective LED example is weighed out, mixed with m_{silicone} (in g) of an optically transparent silicone and subsequently mixed in a planetary centrifugal mixer to give a homogeneous mixture, so that the phosphor concentration in the overall mass is cₚ (in wt. %). The silicone/phosphor mixture obtained in this way is applied to the chip of a near-UV semiconductor LED with the aid of an automatic dispenser and cured with supply of heat. The near-UV semiconductor LEDs used for the LED characterisation in the present examples have an emission wavelength of 407 nm and are operated at a current strength of 350 mA. The photometric characterisation of the LED is carried out using an Instrument Systems CAS 140 spectrometer and an attached ISP 250 integration sphere. The LED is characterised via determination of the wavelength-dependent spectral power density. The resultant spectrum of the light emitted by the LED is used to calculate the colour point coordinates CIE x and y.

LED Examples with Phosphors According to the Invention

The starting weights of the individual components (phosphor and silicone) and the results of the measurements of the wavelength-dependent spectral power density in accordance with the general procedure indicated above for the construction and measurement of pc-LEDs are summarised in Table 1.

TABLE 1
Results of the LEDs according to the invention

| | LED Example a | LED Example b | LED Example c | LED Example d |
|---|---|---|---|---|
| Parameter | SrBa₈(BN₂)₆:Pr³⁺ | SrBa₈(BN₂)₆:Ce³⁺ | Ca₃(BN₂)₂:Eu²⁺ | Mg₃BN₃:Eu²⁺ |
| Phosphor | (from Example 5) | (from Example 4) | (from Example 2) | (from Example 1) |
| M_{Phosphor}/g | 0.350 | 0.350 | 0.350 | 0.350 |
| M_{silicone} | 0.650 | 0.650 | 0.650 | 0.650 |
| Cₚₕₒₛₚₕₒᵣ/wt. % | 35 | 35 | 35 | 35 |
| CIE 1931 x | 0.468 | 0.458 | 0.527 | 0.498 |
| CIE 1931 y | 0.206 | 0.355 | 0.242 | 0.413 |

### DESCRIPTION OF THE FIGURES

FIG. 1: XRD of Mg₃(BN₂)N:Eu²⁺ from Example 1

FIG. 2: Reflection spectrum of Mg₃(BN₂)N:Eu²⁺ from Example 1

FIG. 3: Excitation spectrum of Mg₃(BN₂)N:Eu²⁺ from Example 1

FIG. 4: Emission spectrum of Mg₃(BN₂)N:Eu²⁺ from Example 1

FIG. 5: XRD of Ca₃(BN₂)₂:Eu²⁺ from Example 2

FIG. 6: Reflection spectrum of Ca₃(BN₂)₂:Eu²⁺ from Example 2

FIG. 7: Excitation spectrum of Ca₃(BN₂)₂:Eu²⁺ from Example 2

FIG. 8: Emission spectrum of Ca₃(BN₂)₂:Eu²⁺ from Example 2

FIG. 9: X-ray powder diffraction pattern of Sr₃(BN₂)₂:Eu²⁺ from Ex. 3

FIG. 10: Emission spectrum of Sr₃(BN₂)₂:Eu²⁺ from Example 3

FIG. 11: Excitation spectrum of Sr₃(BN₂)₂:Eu²⁺ from Example 3

FIG. 12: Reflection spectrum of Sr₃(BN₂)₂:Eu²⁺ from Example 3

FIG. 13: X-ray powder diffraction pattern of SrBa₈(BN₂)₆:Ce³⁺ from Ex. 4

FIG. 14: Emission spectrum of SrBa₈(BN₂)₆:Ce³⁺ from Example 4

FIG. 15: Excitation spectrum of SrBa₈(BN₂)₆:Ce³⁺ from Example 4

FIG. 16: Reflection spectrum of SrBa₈(BN₂)₆:Ce³⁺ from Example 4

FIG. 17: X-ray powder diffraction pattern of SrBa₈(BN₂)₆:Pr³⁺ from Example 5

FIG. 18: Emission spectrum of SrBa₈(BN₂)₆:Pr³⁺ from Example 5

FIG. 19: Excitation spectrum of SrBa₈(BN₂)₆:Pr³⁺ from Example 5

FIG. 20: Reflection spectrum of SrBa₈(BN₂)₆:Pr³⁺ from Example 5

FIG. 21: X-ray powder diffraction pattern of Sr₂BN₂F:Eu²⁺ from Example 6

FIG. 22: Emission spectrum of Sr₂BN₂F:Eu²⁺ from Example 6

FIG. 23: Excitation spectrum of Sr₂BN₂F:Eu²⁺ from Example 6

FIG. 24: Reflection spectrum of Sr₂BN₂F:Eu²⁺ from Example 6

FIG. 25: LED Example a with the phosphor from Example 5

FIG. 26: LED Example b with the phosphor from Example 4

FIG. 27: LED Example c with the phosphor from Example 2

FIG. 28: LED Example d with the phosphor from Example 1

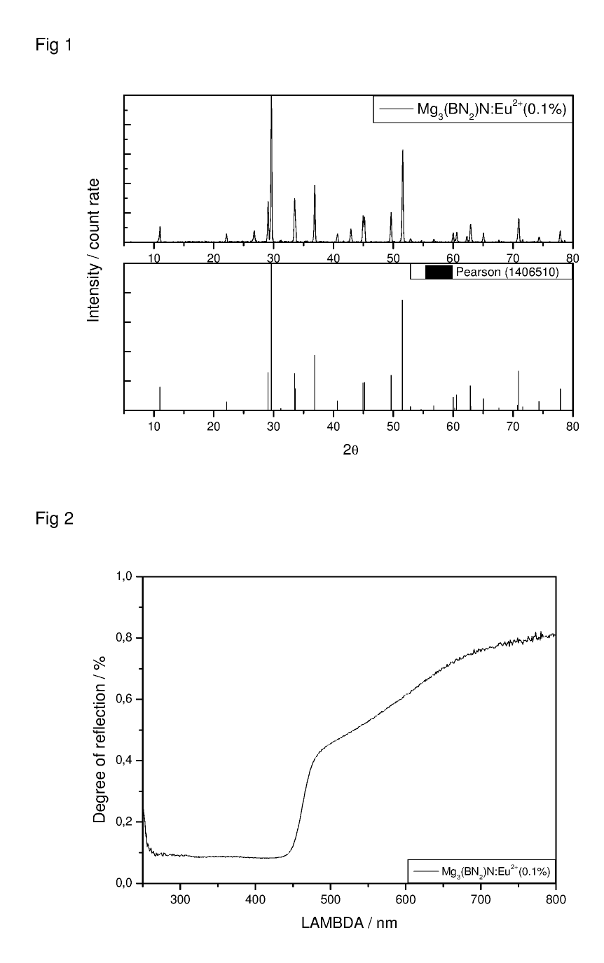

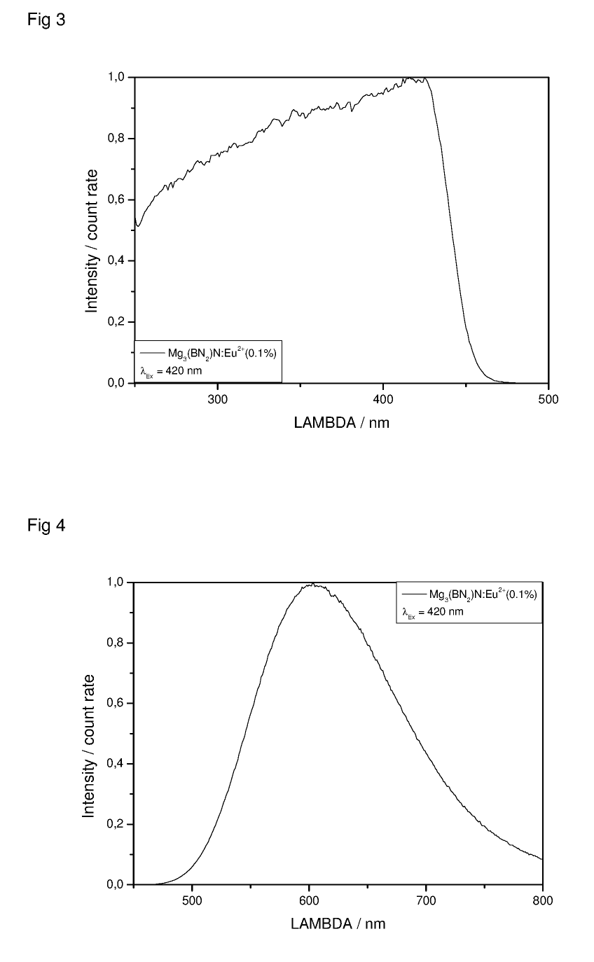

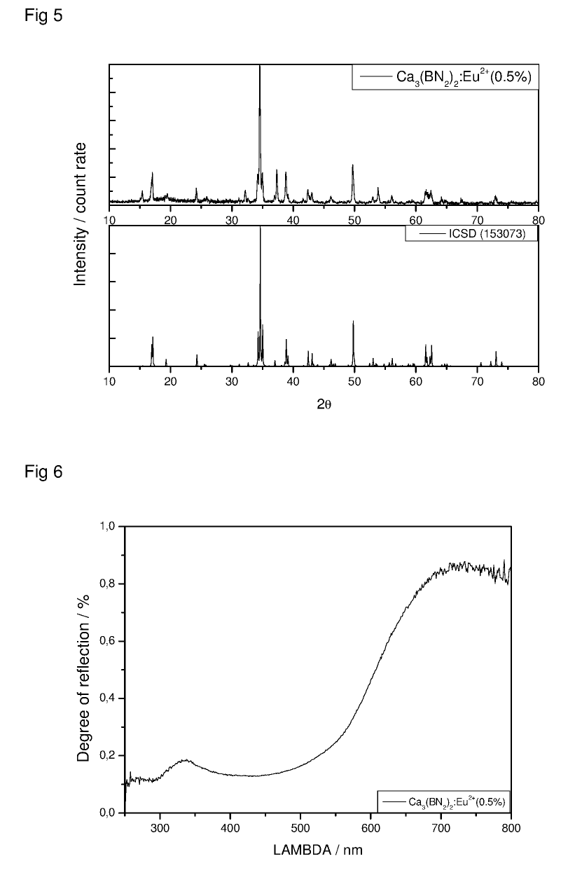

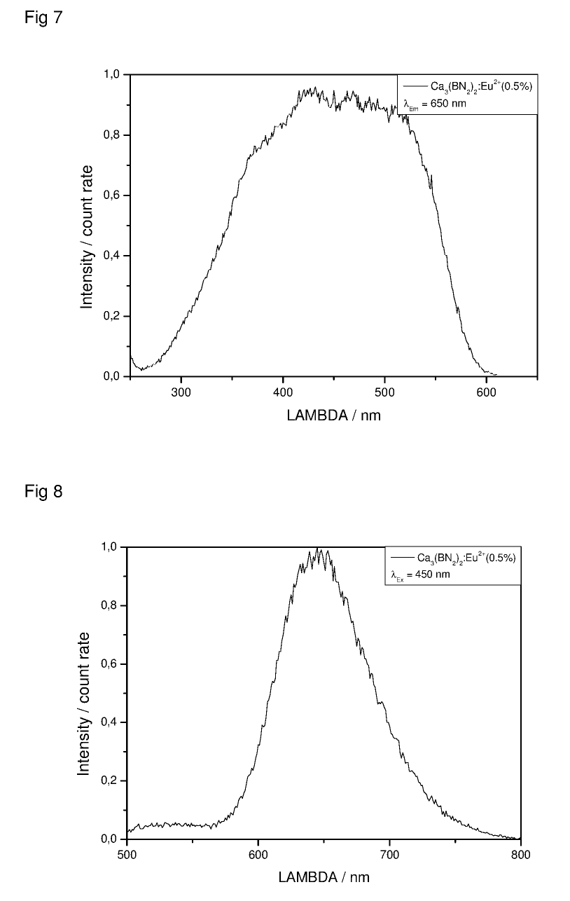

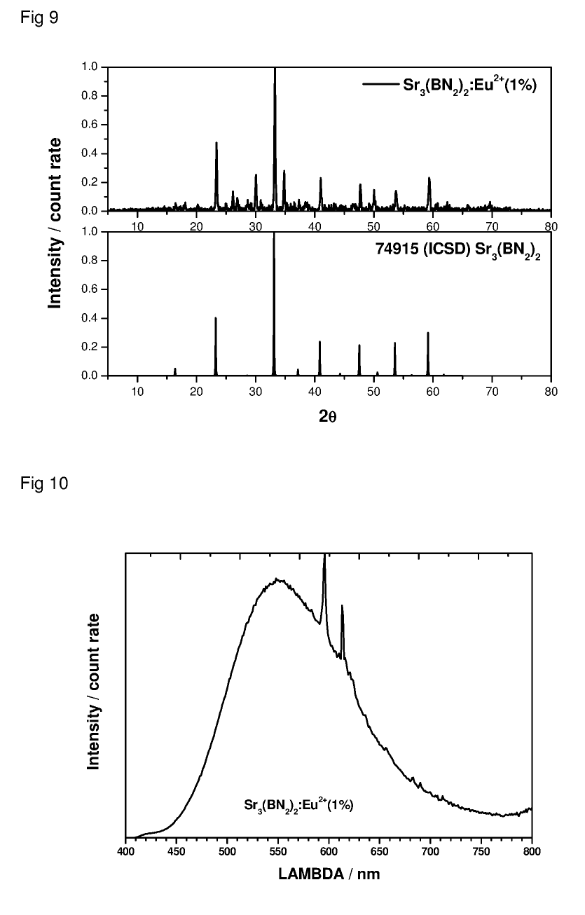

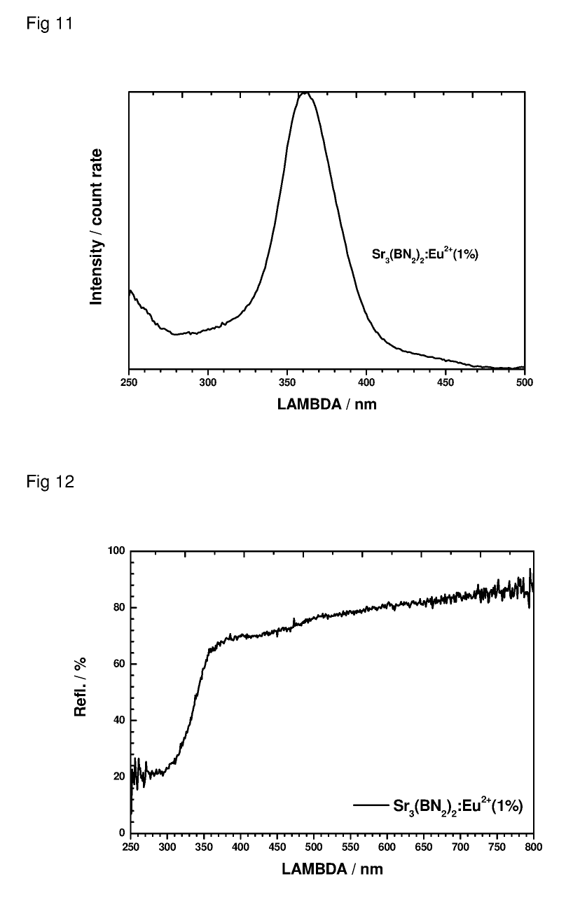

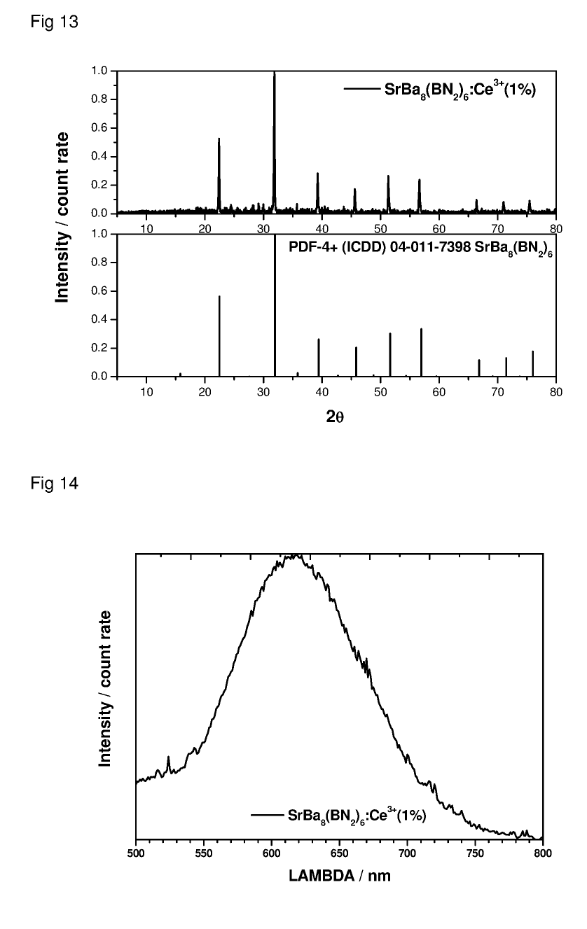

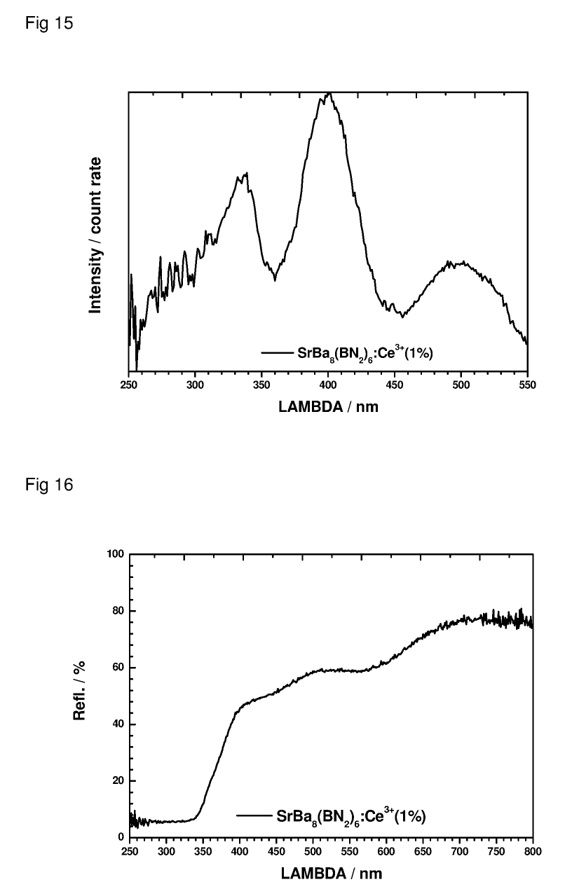

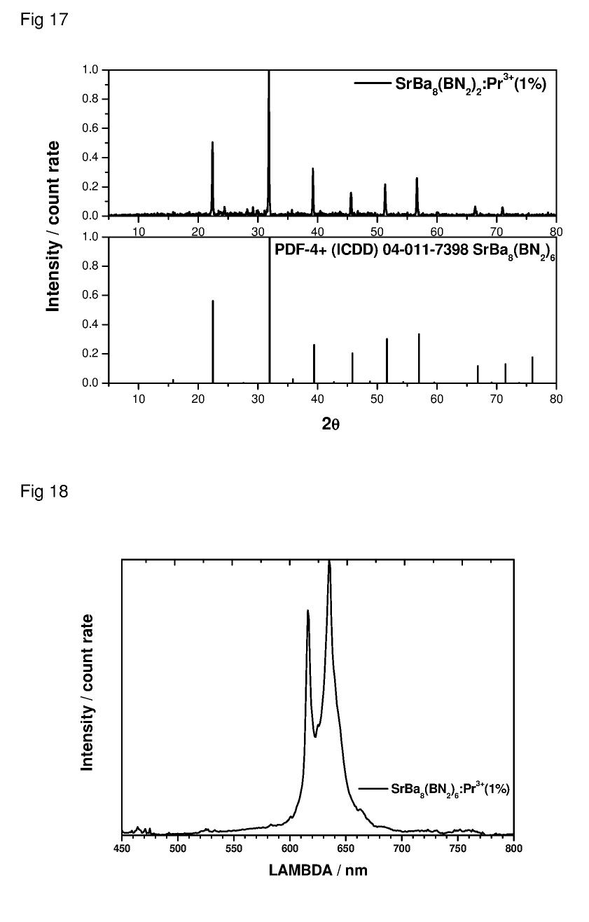

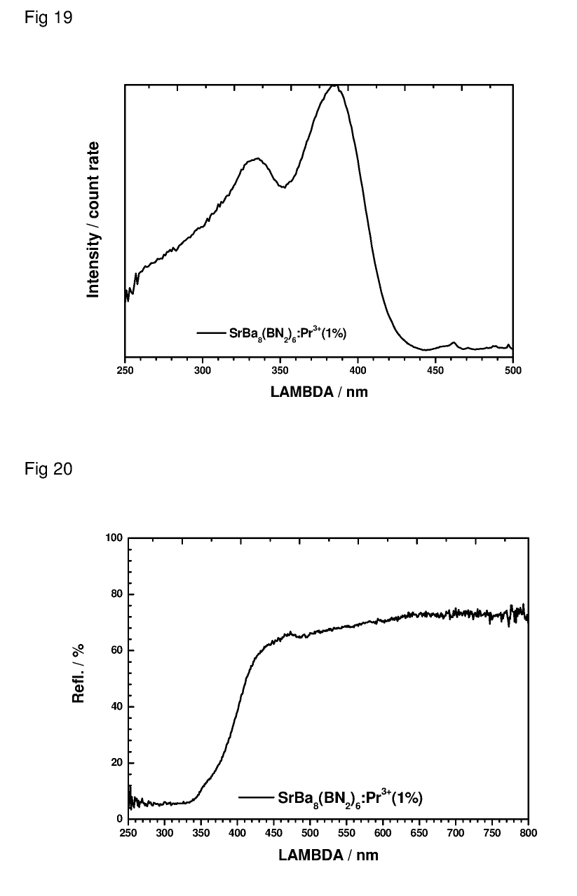

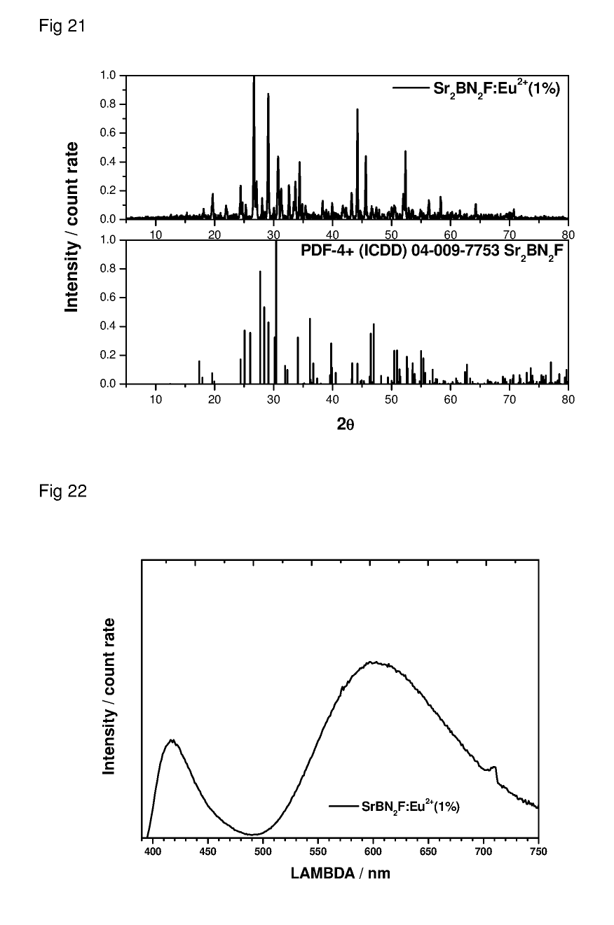

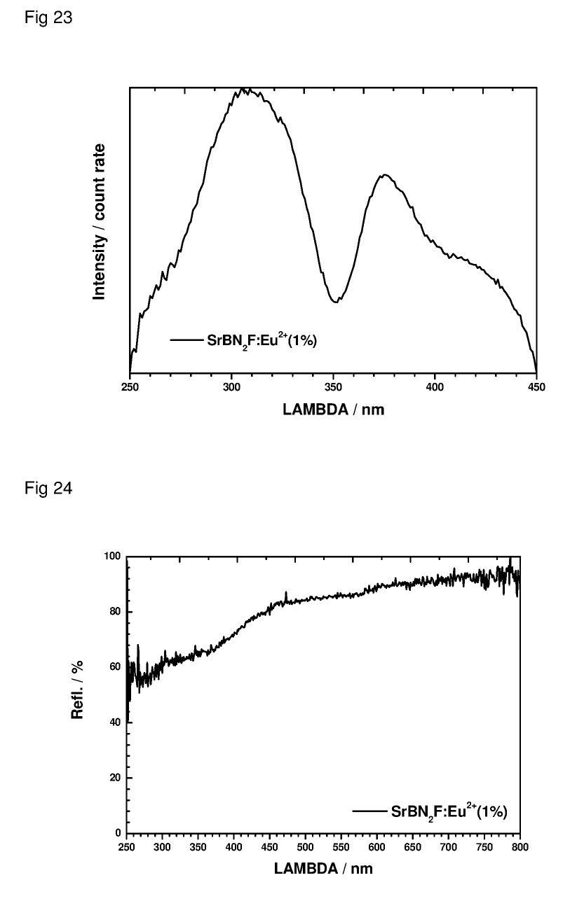

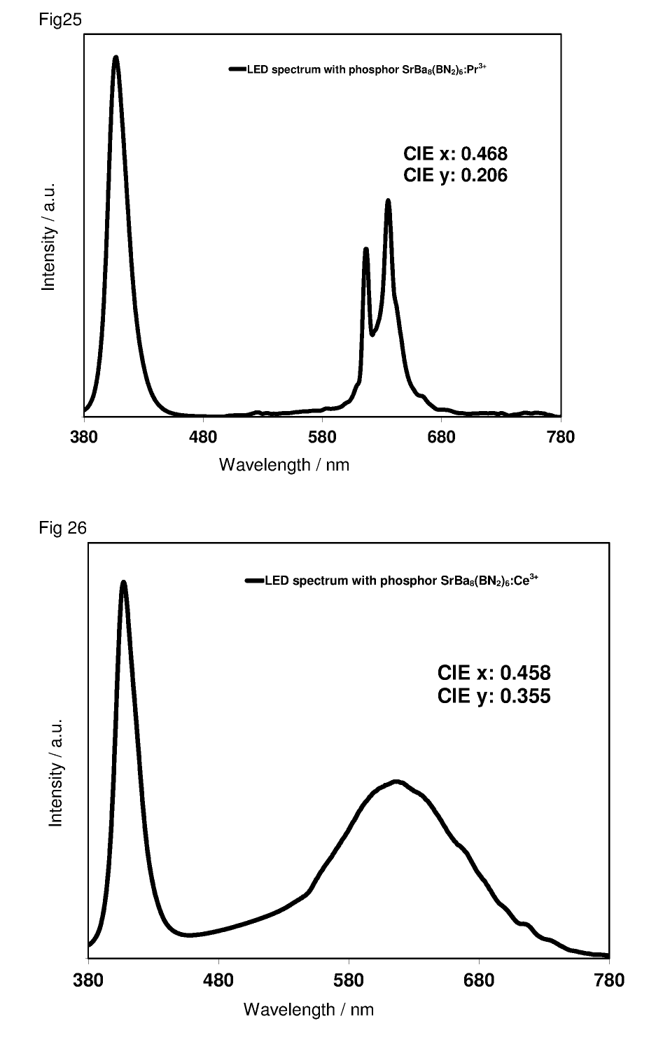

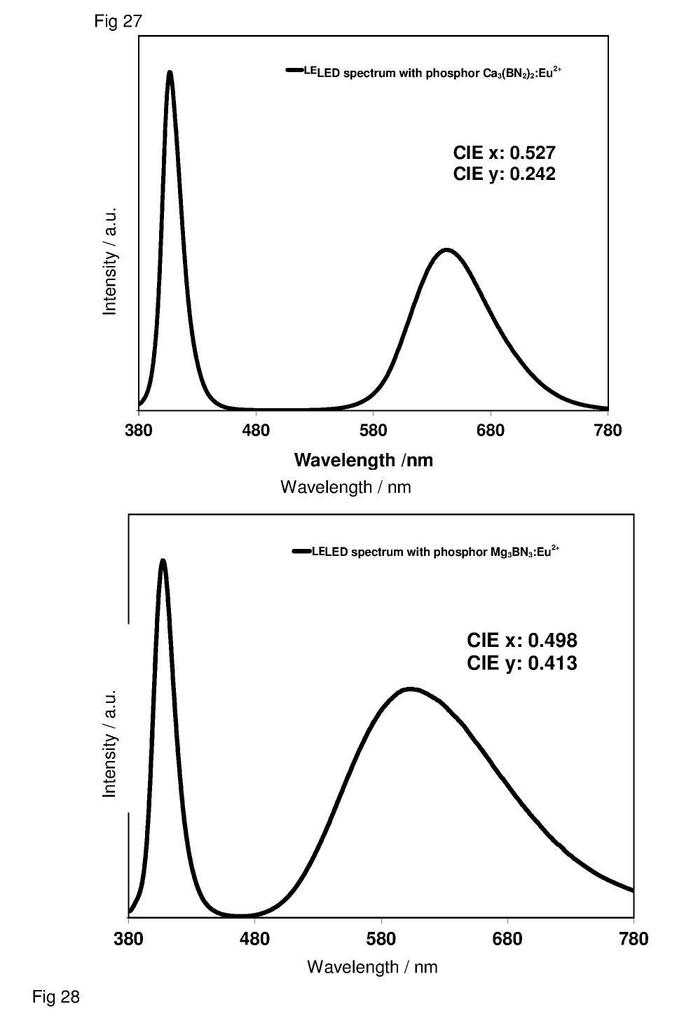

1. Compound of the formula (1) which is doped with europium, cerium, samarium and/or praseodymium, where the degree of doping is up to 10 mol %,
Aₐ(EA)_{b}(Ln)_{c}BₑN_{2e+f}O_{g}(BNO)ₕ(Hal)ᵢ formula (1)
where the following applies to the symbols and indices used:
A are one or more elements selected from the group consisting of Li, Na and K;
EA are one or more elements selected from the group consisting of Mg, Ca, Sr and Ba;
Ln are one or more elements selected from the group consisting of Sc, Y, La, Gd and Lu;
Hal are one or more elements selected from the group consisting of F, Cl, Br and I;
0≦a≦3;
0≦b≦5;
0≦c≦6;
1≦e≦4;
0≦f≦2;
0≦g≦6;
0≦h≦1;
0≦i≦1;
where the following applies to the indices:
a+2b+3c=3e+3f+2g+2h+i;
2≦a+b+c≦6;
2≦e+f+g+h+i≦6;
the compound Ca₂BN₂F:Eu is excluded from the invention.

2. Compound according to claim 1, characterised in that the compound is doped with Eu²⁺ or Eu³⁺, where Eu²⁺ replaces two alkali metals A or one alkaline-earth metal EA or Eu³⁺ replaces one lanthanoid metal Ln, or in that the compound is doped with Ce³⁺, where Ce³⁺ replaces one alkaline-earth metal EA or one lanthanoid metal Ln, or in that the compound is doped with Sm²⁺ or Sm³⁺, where Sm²⁺ replaces two alkali metals A or one alkaline-earth metal EA or Sm³⁺ replaces one lanthanoid metal Ln, or in that the compound is doped with Pr³⁺, where Pr³⁺ replaces one alkaline-earth metal EA or one lanthanoid metal Ln.

3. Compound according to claim 1, characterised in that the compound contains precisely one dopant, where the proportion of the dopant is 0.1 to 5 mol %.

4. Compound according to claim 1, characterised in that the boron-containing unit stands for BN₂ and the index e stands for 1, 2, 3 or 4.

5. Compound according to claim 1 which is doped with europium, cerium, samarium or praseodymium, where the degree of doping is up to 10 mol %, of the formula (2),
(EA)_{b}(Ln)_{c}(BN₂)ₑN_{f}O_{g}(BNO)ₕ formula (2)
where EA and Ln have the meanings given in claim 1 and the following applies to the indices used:
0≦b≦4;
0≦c≦6;
1≦e≦4;
0≦f≦3;
0≦g≦6;
0≦h≦1;
where the following applies to the indices:
2b+3c=3e+3f+2g+2h;
with the proviso that a maximum of one of indices f, g and h is >0.

6. Compound according to claim 5, selected from the compounds (2-Eu) and (2-Ce) and (2-Sm-a) and (2-Sm-b) and (2-Pr),
(EA)_{b-x}(Ln)_{c}(BN₂)ₑN_{f}O_{g}(BNO)ₕ:Euₓ formula (2-Eu)
(EA)_{b}(Ln)_{c-y}(BN₂)ₑN_{f}O_{g}(BNO)ₕ:Ce_{y} formula (2-Ce)
(EA)_{b-x}(Ln)_{c}(BN₂)ₑN_{f}O_{g}(BNO)ₕ:Smₓ formula (2-Sm-a)
(EA)_{b}(Ln)_{c-y}(BN₂)ₑN_{f}O_{g}(BNO)ₕ:Sm_{y} formula (2-Sm-b)
(EA)_{b}(Ln)_{c-y}(BN₂)ₑN_{f}O_{g}(BNO)ₕ:Pr_{y} formula (2-Pr)
where the symbols and indices used have the meanings given in claim 5 and furthermore:
0≦x≦0.05;
0≦y≦0.05;
b>x in formulae (2-Eu) and (2-Sm-a);
c>y in formulae (2-Ce), (2-Sm-b) and (2-Pr).

7. Compound according to claim 1, selected from the compounds of the formulae (2A) to (2R), each of which is doped with europium, cerium, samarium or praseodymium, where the degree of doping is up to 10 mol %,
(EA)_{4,5}(BN₂)₃ formula (2A)
(EA)₃(BN₂)_{2-f}N_{f} formula (2B)
(Ln)₃(BN₂)₃ formula (2C)
(EA)₃(Ln)₂(BN₂)₄ formula (2D)
(EA)(Ln)₃(BN₂)₃(BNO) formula (2E)
(EA)₃(Ln)₂(BN₂)₂ formula (2F)
(EA)₃(Ln)(BN₂)₃ formula (2G)
(Ln)₃(BN₂)O₃ formula (2H)
A(EA)₄(BN₂)₃ formula (2I)
(EA)₄(BN₂)₂O formula (2J)
(EA)₆BN₅ formula (2K)
A(EA)₄(BN₂)₃ formula (2L)
(EA)₂(BN₂)(Hal) formula (2M)
(Ln)₆(BN₃)O₆ formula (2N)
(Ln)₅(B₄N₉) formula (2O)
(Ln)₆(B₄N₁₀) formula (2P)
(Ln)₄(B₂N₅) formula (2Q)
(Ln)₅(B₂N₆) formula (2R),
where the symbols and indices used have the meanings given in claim 1.

8. Compound according to claim 1, selected from the compounds (2A-Eu) to (2R-Pr),
(EA)_{4,5-x}(BN₂)₃:Euₓ formula (2A-Eu)
(EA)_{4,5}(BN₂)₃:Ce formula (2A-Ce)
(EA)_{4,5-x}(BN₂)₃:Smₓ formula (2A-Sm)
(EA)₃₋ₓ(BN₂)_{2-f}N_{f}:Euₓ formula (2B-Eu)
(EA)₃(BN₂)_{2-f}N_{f}:Ce formula (2B-Ce)
(EA)₃₋ₓ(BN₂)_{2-f}N_{f}: Smₓ formula (2B-Sm)
(Ln)_{3-y}(BN₂)₃:Ce_{y} formula (2C-Ce)
(Ln)_{3-y}(BN₂)₃:Sm_{y} formula (2C-Sm)
(Ln)_{3-y}(BN₂)₃:Pr_{y} formula (2C-Pr)
(EA)₃₋ₓ(Ln)₂(BN₂)₄:Euₓ formula (2D-Eu)
(EA)₃₋ₓ(Ln)₂(BN₂)₄:Smₓ formula (2D-Sm-a)
(EA)₃(Ln)_{2-y}(BN₂)₄:Ce_{y} formula (2D-Ce)
(EA)₃(Ln)_{2-y}(BN₂)₄:Sm_{y} formula (2D-Sm-b)
(EA)₃(Ln)_{2-y}(BN₂)₄:Pr_{y} formula (2D-Pr)
(EA)₁₋ₓ(Ln)₃(BN₂)₃(BNO):Euₓ formula (2E-Eu)
(EA)₁₋ₓ(Ln)₃(BN₂)₃(BNO):Smₓ formula (2E-Sm-a)
(EA)(Ln)_{3-y}(BN₂)₃(BNO):Ce_{y} formula (2E-Ce)
(EA)(Ln)_{3-y}(BN₂)₃(BNO):Sm_{y} formula (2E-Sm-b)
(EA)(Ln)_{3-y}(BN₂)₃(BNO):Pr_{y} formula (2E-Pr)
(EA)₃₋ₓ(Ln)₂(BN₂)₂:Euₓ formula (2F-Eu)
(EA)₃₋ₓ(Ln)₂(BN₂)₂:Smₓ formula (2F-Sm-a)
(EA)₃(Ln)_{2-y}(BN₂)₂:Ce_{y} formula (2F-Ce)
(EA)₃(Ln)_{2-y}(BN₂)₂:Sm_{y} formula (2F-Sm-b)
(EA)₃(Ln)_{2-y}(BN₂)₂:Pr_{y} formula (2F-Pr)
(EA)₃₋ₓ(Ln)(BN₂)₃:Euₓ formula (2G-Eu)
(EA)₃₋ₓ(Ln)(BN₂)₃:Smₓ formula (2G-Sm-a)
(EA)₃(Ln)_{1-y}(BN₂)₃:Ce_{y} formula (2G-Ce)
(EA)₃(Ln)_{1-y}(BN₂)₃:Sm_{y} formula (2G-Sm-b)
(EA)₃(Ln)_{1-y}(BN₂)₃:Pr_{y} formula (2G-Pr)
(Ln)_{3-y}(BN₂)O₃:Ce_{y} formula (2H-Ce)
(Ln)_{3-y}(BN₂)O₃:Sm_{y} formula (2H-Sm)
(Ln)_{3-y}(BN₂)O₃:Pr_{y} formula (2H-Pr)
A(EA)₄(BN₂)₃:Euₓ formula (2I-Eu)
A(EA)₄₋ₓ(BN₂)₃:Smₓ formula (2I-Sm)
(EA)₄₋ₓ(BN₂)₂O:Euₓ formula (2J-Eu)
(EA)₄₋ₓ(BN₂)₂O:Smₓ formula (2J-Sm)
(EA)₆₋ₓ,BN₅:Euₓ formula (2K-Eu)
(EA)₆₋ₓ,BN₅:Smₓ formula (2K-Sm)
A(EA)₄₋ₓ(BN₂)₃:Euₓ formula (2L-Eu)
A(EA)₄₋ₓ(BN₂)₃:Smₓ formula (2L-Sm)
(EA)₂₋ₓ(BN₂)(Hal):Euₓ formula (2M-Eu)
(EA)₂₋ₓ(BN₂)(Hal):Smₓ formula (2M-Sm)
(Ln)_{6-y}(BN₃)O₆:Ce_{y} formula (2N-Ce)
(Ln)_{6-y}(BN₃)O₆:Sm_{y} formula (2N-Sm)
(Ln)_{6-y}(BN₃)O₆:Pr_{y} formula (2N-Pr)
(Ln)_{5-y}(B₄N₉):Ce_{y} formula (2O-Ce)
(Ln)_{5-y}(B₄N₉):Sm_{y} formula (2O-Sm)
(Ln)_{5-y}(B₄N₉):Pr_{y} formula (2O-Pr)
(Ln)_{6-y}(B₄N₁₀):Ce_{y} formula (2P-Ce)
(Ln)_{6-y}(B₄N₁₀):Sm_{y} formula (2P-Sm)
(Ln)_{6-y}(B₄N₁₀):Pr_{y} formula (2P-Pr)
(Ln)_{4-y}(B₂N₅):Ce_{y} formula (2Q-Ce)
(Ln)_{4-y}(B₂N₅):Sm_{y} formula (2Q-Sm)
(Ln)_{4-y}(B₂N₅):Pr_{y} formula (2Q-Pr)
(Ln)_{5-y}(B₂N₆):Ce_{y} formula (2R-Ce)
(Ln)_{5-y}(B₂N₆):Sm_{y} formula (2R-Sm)
(Ln)_{5-y}(B₂N₆):Pr_{y} formula (2R-Pr),
where
0≦x≦0.05;
0≦y≦0.05;
b>x in formulae (2-Eu) and (2-Sm-a);
c>y in formulae (2-Ce), (2-Sm-b) and (2-Pr).

9. Compound according to claim 1, characterised in that A is selected, identically or differently, from Li and Na and in that EA is selected, identically or differently, from Ca, Sr and Ba and in that Ln is selected, identically or differently, from Y, Lu and Gd and in that Hal is selected, identically or differently, from F and Cl.

10. Compound according to claim 1, characterised in that A is equal to Li and in that EA is selected, identically or differently, from Sr and Ba and in that Ln is selected, identically or differently, from Y, Lu and Gd and in that Hal is equal to F.

11. Compound according to claim 1, characterised in that the compound has a coating on the surface.

12. Process for the preparation of a compound according to the invention according to claim 1, characterised by the following process steps:
a) preparation of a mixture comprising a nitride of one or more of the cations A, EA and/or Ln, where the symbols have the meanings given in claim 1, in addition boron nitride and a europium, cerium, samarium and/or praseodymium source;
b) calcination of the mixture under non-oxidising conditions.

13. A phosphor which comprises a compound according to claim 1.

14. Light source comprising a primary light source and at least one compound according to claim 1.

15. Light source according to claim 14, characterised in that it is a phosphor-converted LED.
